(19) United States
(12) Patent Application Publication
(10) Pub. No.: US 2018/0165877 A1
(43) Pub. Date: Jun. 14, 2018

(54) METHOD AND APPARATUS FOR VIRTUAL REALITY ANIMATION

(71) Applicant: Nathaniel Winckler, Georgetown, KY (US)

(72) Inventor: Nathaniel Winckler, Georgetown, KY (US)

(21) Appl. No.: 15/372,729

(22) Filed: Dec. 8, 2016

(51) Int. Cl. G06T 19/00; G06T 13/00; G06F 3/01; G06F 3/0484; G06F 3/0354

(52) U.S. Cl. CPC G06T 19/006; G06T 19/003; G06F 3/03545; G06F 3/011; G06F 3/04845; G06T 13/00

(57) ABSTRACT

A method and apparatus for improving virtual reality based animation and design. Specifically, the method and process assists artists in creating artwork in a virtual reality space and for exporting this artwork. A virtual reality design environment defines a virtual design palette to present a user with navigation and content selection options while a virtual art tool provides a user with a configurable creation tool.

### FIELD OF THE INVENTION

The embodiments of the invention relate to a method and apparatus for improving virtual reality based animation. Specifically, the embodiments of the invention relate to a method and process for assisting artists in creating artwork in a virtual reality space and for exporting this artwork.

### BACKGROUND

Artists such as graphic designers and animators work in computer aided design software, three-dimensional (3D) animation software and similar computerized environments for drawing and creating artwork and designs. The interface for using such software is typically via an input device such as a mouse, or via a tablet and stylus interface. This software utilizes basic windowing and menu driven interfaces to allow a user to select between various settings and options for creating projects in these environments. These software applications often recreate various aspects or approximations of real world art tools such as brushes and pens. However, much of computer aided design goes beyond what is possible from real world art tools. These software applications allow a user to compose complex two-dimensional and 3D artwork using filters, layers, artificial lighting, and similar tools that either do not exist for real world art production or go far beyond real world art tools.

Virtual reality (VR) is a growing area of development for media. Virtual reality is a computer-generated simulation of three-dimensional space or environments that can be dynamically interacted with and navigated by a user using specialized equipment such as a head mounted display and/or gloves or similar accessories that track the position of the body of the user. Virtual reality is typically utilized for providing gaming or audio/visual entertainment for a user. Content for the VR environment is generated using conventional computer interfaces and 2D/3D design software.

Similarly, a real-world environment can be augmented with computer generated content by using specialized equipment that projects or displays computer generated content into the view of a user such as in specialized glasses or projection onto a glass surface. In other cases, a live video input of a camera may have computer generated input inserted into it, such as in a camera smartphone application. This is referred to as augmented reality (AR) software. Content for AR software is also generated using conventional computer interfaces and 2D/3D design software.

### BRIEF DESCRIPTION OF THE DRAWINGS

The present invention is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one. Further, when a particular feature, structure, or characteristic is described in connection with an embodiment, it is submitted that it is within the knowledge of one skilled in the art to effect such feature, structure, or characteristic in connection with other embodiments whether or not explicitly described.

FIG. 1 is a flowchart of one embodiment of a hardware architecture for a virtual reality or augmented reality (VR/AR) design environment.

FIG. 2 is a diagram of one embodiment of a virtual design palette for selecting and configuring virtual art tools.

FIG. 3 is a diagram of one embodiment of a virtual art tool being utilized in conjunction with the virtual design palette.

FIG. 4 is a diagram of one embodiment of the navigation interface for a set of frames of an AR/VR environment via the virtual design palette.

FIG. 5 is a diagram of one embodiment of the navigation of a set of frames of an AR/VR environment via the virtual design palette.

FIG. 6 is a flowchart of one embodiment of a process for the navigation of a set of frames of an AR/VR environment via a virtual design palette.

FIG. 7 is a diagram of one embodiment of a virtual art tool.

FIG. 8 is a diagram of one embodiment of the adjustment or configuration of the virtual art tool.

FIG. 9 is a flowchart of one embodiment of a process for the configuration of the virtual art tool.

FIG. 10 is a diagram of one embodiment of the virtual art tool being utilized for erasing content.

FIG. 11 is a diagram of one embodiment of a software architecture for the VR/AR design environment.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description. It will be appreciated, however, by one skilled in the art, that the invention may be practiced without such specific details. Those of ordinary skill in the art, with the included descriptions, will be able to implement appropriate functionality without undue experimentation.

The operations of the flow diagrams will be described with reference to the exemplary embodiment of the figures. However, it should be understood that the operations of the flow diagrams can be performed by embodiments of the invention other than those discussed with reference to the figures, and the embodiments discussed with reference to the figures can perform operations different than those discussed with reference to the flow diagrams of the figures. Some of the figures provide example topologies and scenarios that illustrate the implementation of the principles and structures of the other figures.

The techniques shown in the figures can be implemented using code and data stored and executed on one or more electronic devices (e.g., a computer, server, workstation, an end station, a network element, etc.). Such electronic devices store and communicate (internally and/or with other electronic devices over a network) code and data using non-transitory machine-readable or computer-readable media, such as non-transitory machine-readable or computer-readable storage media (e.g., magnetic disks; optical disks; random access memory; read only memory; flash memory devices; and phase-change memory). In addition, such electronic devices typically include a set of one or more processors coupled to one or more other components, such as one or more storage devices, user input/output devices (e.g., a keyboard, a touch screen, and/or a display), and network connections. The coupling of the set of processors and other components is typically through one or more busses and bridges (also termed as bus controllers). The storage devices represent one or more non-transitory machine-readable or computer-readable storage media and non-transitory machine-readable or computer-readable communication media. Thus, the storage device of a given electronic device typically stores code and/or data for execution on the set of one or more processors of that electronic device. Of course, one or more parts of an embodiment of the invention may be implemented using different combinations of software, firmware, and/or hardware.

As used herein, a network element (e.g., a router, switch, bridge, etc.) is a piece of networking equipment, including hardware and software, that communicatively interconnects other equipment on the network (e.g., other network elements, end stations, etc.). As used herein, a network is a set of interconnected devices that are capable of communicating data that enables the transfer of data between any two network elements in the network. The network can include links that are wired or wireless mediums for communication and can include any number of devices that communicate with any combination of networking protocols and technologies.

Overview

The embodiments provide a set of processes and a system for enabling a user to generate content in a virtual reality/augmented reality environment. The VR/AR art studio software environment provides a set of user interface mechanisms including a virtual design palette and virtual art tool that are displayed within a VR/AR environment to enable a user to interact with the VR/AR environment as well as create content in the VR/AR environment. The virtual design palette is user configurable to enable the user to have any combination of tools available to the user to enable the user to efficiently design and create in the VR/AR environment.

The virtual art tool is a representation in the VR/AR environment of a drawing or painting or similar tool that the user interacts with to create content in the VR/AR environment. The virtual art tool provides additional configuration options and VR/AR environment management options for the user to efficiently navigate the VR/AR environment and the content created in that environment.

The VR/AR environment consists of a 3D space in which content objects can be placed and created using the virtual design palette and the virtual art tool. In addition to the 3D space, which is navigable as an x, y, z coordinate space, the VR/AR environment encompasses a sequence of frames or a timeline of changes within the VR/AR 3D space. Thus, with the frame sequence or timeline, animations of objects or effects in the 3D space can be defined by associating changes in objects with specific frames or points of time in the timeline.

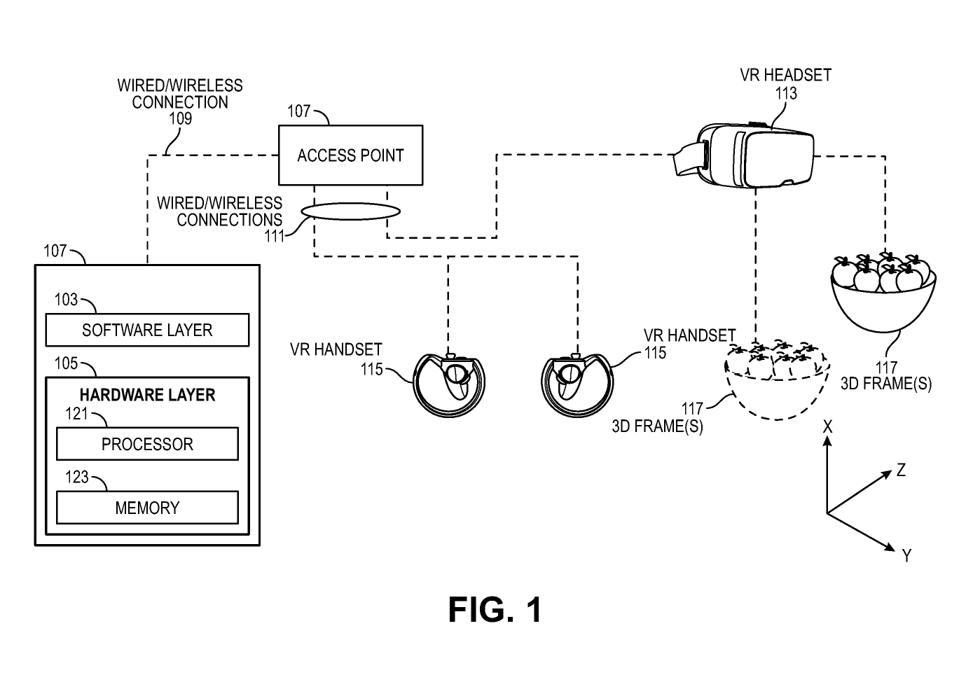

FIG. 1 is a diagram of one embodiment of the hardware architecture for the VR/AR design environment. The hardware architecture includes a computing device 101 that executes the software layer 103 that generates and manages the manipulation of the VR/AR design environment. The software layer is discussed in greater detail herein below and encompasses all of the user interface elements, the data structures, and coding that render and store the VR/AR design environment.

The hardware layer 105 of the computing device 101 can include a processor 121 and memory 123. The processor 121 can be any type of processing device including a central processing unit (CPU), an application specific integrated circuit (ASIC) or similar processing devices. The processor 121 can be a single processor a or a set of processing devices. In a further embodiment, the hardware layer 105 can be a distributed hardware layer such as in a cloud computing environment, network processing and hardware resources and similar hardware configurations. The memory 123 can be any type of dynamic or static storage system including any type of non-transitory computer-readable medium. The memory 123 can include a set of storage devices in any combination and hierarchical organization such as random access memory and persistent storage devices. The memory 123 may be local memory devices or distributed storage devices or combinations thereof. The storage can be in a server, data center or cloud computing environment. The code for the software layer 103 may be stored in the memory 123 or encoded into any combination of memory 123 and integrated circuits.

The hardware layer 105 may include a set of communication devices. A ‘set,’ as used herein, refers to any positive whole number of items including one item. The communication devices may enable the computing device 101 to communicate with a set of accessories in the form of a VR headset 113 or similar user display device. Additional accessories such as VR handsets or similar body tracking devices may also be in communication with the computing device 101 via either a wired or wireless connection 109. In some embodiments, the computing device communicates with peripheral accessories via an access point 107 such as a wireless router, hub, switch or similar networking device. The access point 107 may implement any wireless or wired communication standard 111 to enable communication with the peripheral devices. The access point 107 may implement Institute of Electrical and Electronics Engineers (IEEE) 802.11, Bluetooth or similar communication protocols. In other embodiments, the communication device in the computing device 101 is able to directly communicate with the peripheral devices using similar communication protocols.

The peripheral devices include a VR headset 113 or similar display device. A VR headset 113 is discussed herein by way of example and not limitation. The VR headset 113 may be designed to be strapped to the head of a user to position a display or set of displays in front of the eyes of the user to enable the user to view the VR/AR design environment and content such as content objects in the frames 117 of the VR/AR design environment. In some embodiments, the set of displays provide the user a stereoscopic perspective of the VR/AR design environment. The VR headset 113 can have any shape or size and have any display characteristics sufficient to display the VR/AR design environment. The display of the VR headset 113 is driven by the software layer 103 that renders the VR/AR design environment and provides user interface elements for it. In some embodiments, the VR headset 113 also include sensors for tracking the head position and orientation of the user to enable the software layer 103 to update the view of the VR design environment in the same manner as moving one's head in a real-world environment alters the perspective of the world.

In some embodiments, the peripherals also include additional components such as VR handsets 115 or similar body position tracking devices. The body position tracking devices can be gloves, controllers or similar articles that are held or worn by the user on any part of the body include full or partial body suits that include sensors to track the absolute or relative position of the user as an input to the software layer 103. In some embodiments, the body tracking devices can include a camera that tracks the movement of the user or similar external sensors that are not directly in contact, held or worn by the user.

The VR/AR design environment is a 3D space that is maintained and handled by the software layer 103 and gives the impression to the user of an interactive alternative reality with objects that are represented in that virtual reality moving within the field of view of the user as the user moves his head and body mimicking the experience of moving through the 3D space of the real world. In addition, the VR/AR design environment includes a sequence of frames 117 or timeline of the changes in the content objects being represented in the VR/AR environment. The VR/AR design environment can display multiple frames or points in time to the user simultaneously with differing frames having different characteristics such as variations of opacity to differentiate the frames and the content in those frames. For sake of clarity and convenience, frames are referred to herein by way of example, whereas similar representations of changes such as timelines are also consistent with the processes and structures described herein.

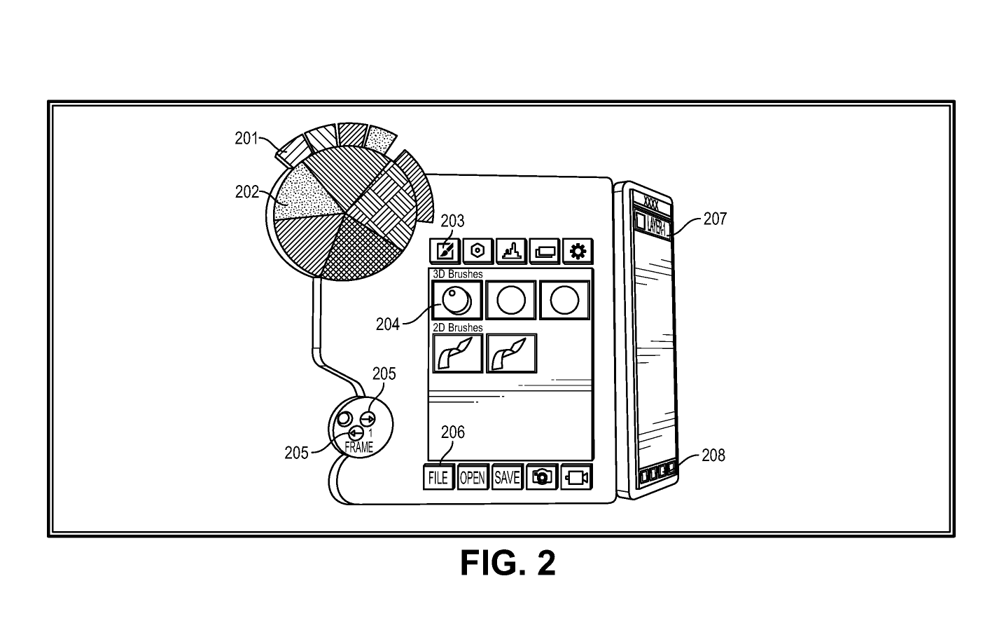

FIG. 2 is a diagram of one embodiment of a virtual design palette for selecting and configuring virtual art tools. In the illustrated embodiments, a set of color swatches is incorporated into the virtual design palette 201. The color swatches 201 are colors selected by the user for use in painting using the virtual art tool. The color swatches 201 can be customized, added, or deleted. The color swatches 201 may be selected via the color and lightness selector 202 or similar mechanism. The selection from the color and lightness selector 202 can be initiated by using a trigger or similar button of the handset or by interaction between the virtual art tool and the virtual design palette. In response to a selection of a color swatch 201 or color from the color and lightness selector 202 the tip of the virtual art tool may change color based on the color selected. The color and lightness selector 202 is illustrated as a circular grid of options, however, it may also have other shapes and organization including a gradient, square shaped grid or similar color and/or lightness selection mechanism.

The virtual design palette may include a set of menus 204 and user interface options that can be navigated by a set of tabs 203 or similar user interface mechanisms. The menu display 204 is an area of the virtual design palette where data, buttons, and other information is displayed and edited. This menu display 204 can display options correlated with the tabs 203. The virtual design palette can include a set of change frame buttons 205. The user can activate these buttons to go forward or backward one frame. A touch of either button or the nearby area can cause the display of adjacent frames in a semi-opaque view of the next frame, previous frame, or both, on top of the current frame's contents (this process may be referred to as “onion skinning” shown and discussed in greater detail herein below).

Other menu and display options can include file and input/output (I/O) operations 206 such as saving, opening, and exporting. Another user interface panel in the virtual design palette can be a layers panel 207. In some embodiments, the layers panel 207 is modular. For example, an entire right “leaf” for listing the layers can be shown or hidden based on user preference. Each of the layers in this list can be shown or hidden in the VR/AR design environment based on user preferences or selections using this panel. Each set of layers is local to a frame. For example, if a frame with 40 layers, then when a new frame is created, the new frame would have, by default, one layer. However, in other embodiments, it is possible for layers to be copied or inherited between frames. In some embodiments, there are “Persistent Layers” not shown in these images where layers “persist” across all or multiple frames. The visibility of each of these persistent layers is synced to each frame so that the user can choose when a persistent layer is visible in their sequence. The layer panel 207 can also include layer operations 208 such as copy, paste, new, and delete.

All options in the virtual design palette can be selected or navigated using body tracking such as the VR handsets to determine whether the user selects or interacts with a menu option of the virtual design palette, which is positioned in the VR/AR environment according to body tracking or at a fixed or selected position. In one example embodiment, the virtual design palette is positioned in the VR/AR environment at a location corresponding to the non-dominant hand of the user, whereas a virtual art tool is positioned according to the dominant hand of the user based on body tracking input.

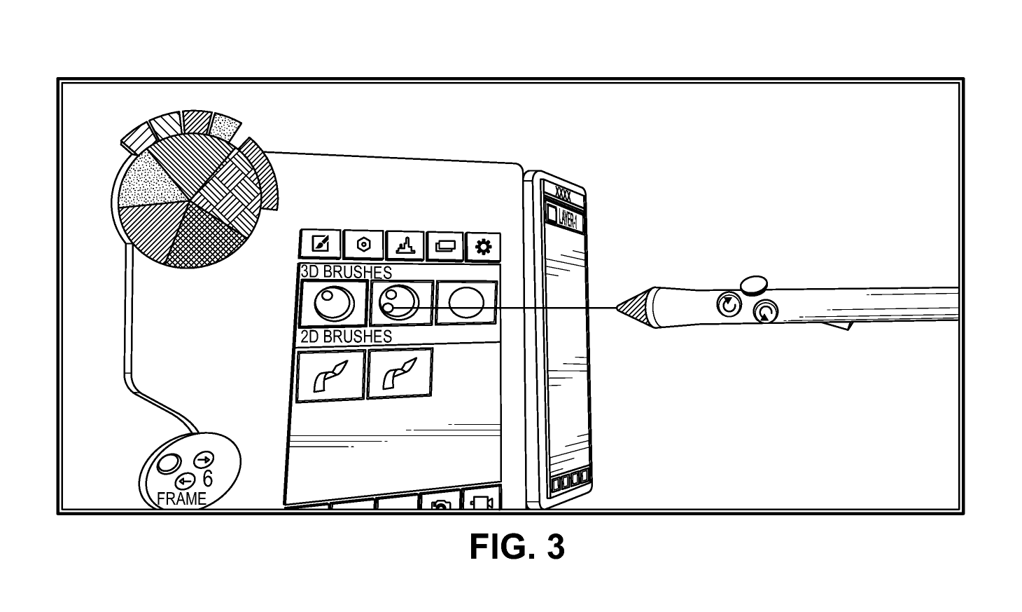

FIG. 3 is a diagram of one embodiment of a virtual art tool being utilized in conjunction with the virtual design palette. Any item displayed via the virtual design palette can be selected by using the virtual art tool to touch or interface with the corresponding option displayed on the virtual design palette. In other embodiments, the virtual art tool serves as a pointer with a visual pointing line to select the options available via the virtual design palette. The option currently selectable may be highlighted or visually indicated when interfaced with or pointed to by the virtual art tool. A physical button or similar mechanism of the peripherals such as a button on a VR handset may be utilized to confirm a selection of an option. In other embodiments, an option may be selected by a motion or change in body position. For example, a user may make a defined movement or ‘gesture’ to select or navigate options presented by the virtual design palette. In some embodiments, gestures and other navigation options are alternatively available as preferred by a user.

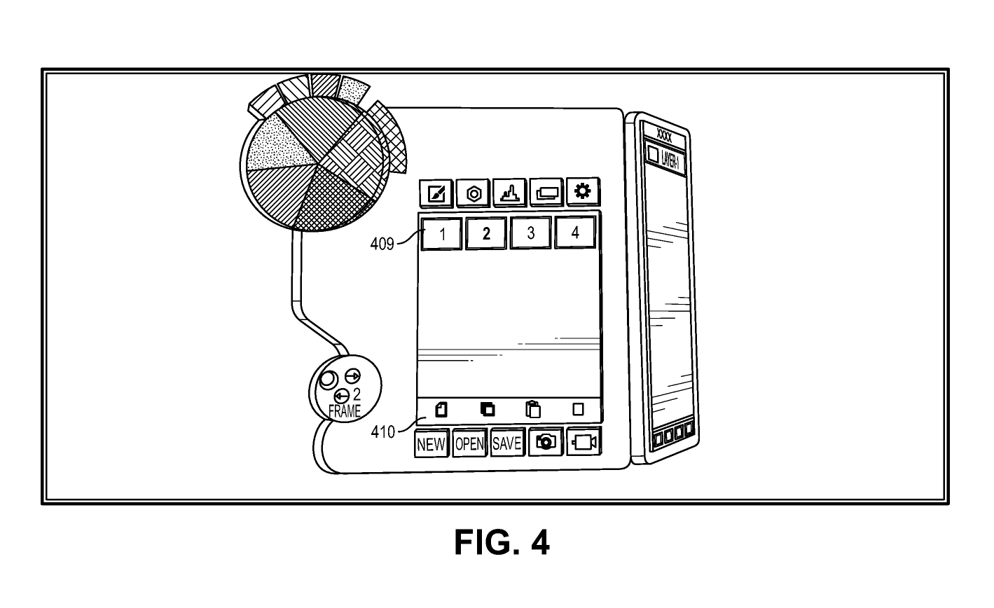

FIG. 4 is a diagram of one embodiment of the navigation interface for a set of frames of an AR/VR environment via the virtual design palette. Selection of a frames tab 409 on the virtual design palette causes the software layer to update the visual display of the virtual design palette to show the set of frames that have been created. The user can select a specific frame by “clicking” on it with the virtual art tool or similarly selecting the frame in the menu. In some embodiments, the frames can be grouped or similarly organized into scenes or similarly categories to assist with navigation and organization. Frame operations 410 can also be selected and utilized from this menu such as copy, paste, new, and delete.

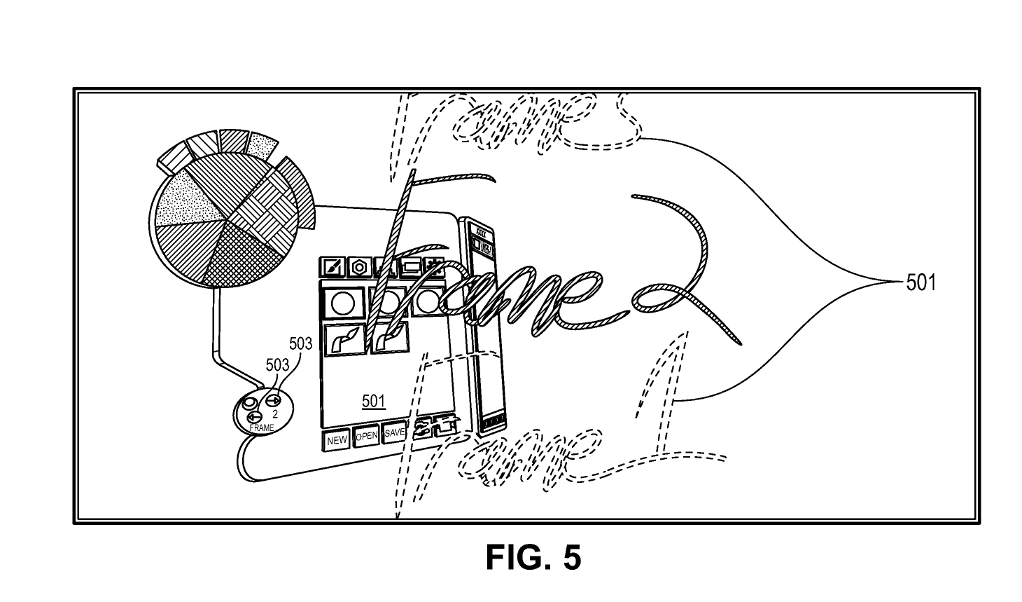

FIG. 5 is a diagram of one embodiment of the navigation of a set of frames 501 of an AR/VR environment via the virtual design palette. In this example, an object in a current frame is displayed with normal opacity. The object in this case is the written object “Frame 2.” The previous and subsequent frames “Frame 1” and “Frame 3,” respectively can be selected and shown by touching a frame navigation button 503. The frame navigation buttons 503 can be interacted with at different levels, with a ‘touch’ of a corresponding button or input mechanism, such as a thumbstick or similar mechanism on a VR handset activating the display of the ‘onion skinning’ of multiple frames with differing opacities or similar differentiation. Then rotation or similar navigation to another frame as the primary frame can be achieved via a full activation or depression of the same input mechanism. In other embodiments, separate physical or virtual input mechanisms can be utilized to make these selections.

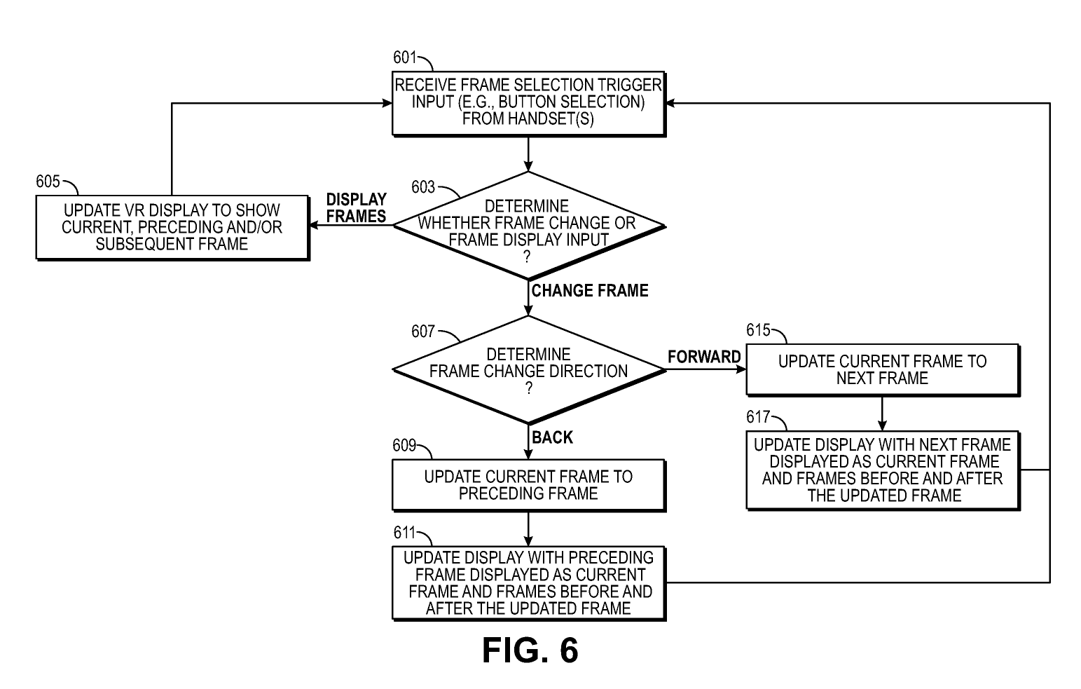

FIG. 6 is a flowchart of one embodiment of a process for the navigation of a set of frames of an AR/VR environment via a virtual design palette. This process is provided by way of example and not limitation. One skilled in the art would understand that frame navigation using variations of this process is within that which is encompassed by the embodiments. The process includes two significant aspects, first enabling the viewing of multiple frames at one time and second selecting a current frame from amongst the set of available frames. As mentioned above, a separate menu may list all available frames or may list a group or subset of the available frames and provide an alternate mechanism for selecting a current frame. In this example embodiment, the frame navigation buttons on the virtual design palette or similar buttons associated with the virtual art tool may be used. These virtual buttons may be tied to physical buttons on a VR handset or similar input mechanisms available to a user.

In one embodiment, an input is received that is associated with a frame selection trigger (Block 601). This can be either an input tied to changing a frame or an input tied to displaying frames (i.e., displaying an ‘onion skinning’ of frames such as the current frame, a previous frame and a subsequent frame relative to a current frame). Receipt of this input causes the software layer to determine which type of an input has been received (Block 603). If the input is associated with activating the display of frames then an update of the display of frames in the VR display screen is initiated by displaying the onion skinning (i.e., the previous, current and/or subsequent frames) or by changing the current frame being displayed to a previous or subsequent frame (Block 605). In other embodiments, any number of frames in a sequence related to the current frame may be displayed as part of the onion skinning display. The frames that are not the current frames may be displayed with differing characteristics to distinguish them from one another such as variances in opacity, tone, coloring or similar visual cues. In some embodiments, this display is initiated even when a change of frame input is received.

Where a change of frame input is received, then the process may determine which direction the change in frame input indicates (i.e., a change to a previous frame (back) or a change to a subsequent frame (forward)) (Block 607). If a selection to move the current frame selection back is received, then the current frame is updated to be the previous frame in the sequence of available frames (Block 609). The process then updates the VR display screen by the software layer is made to show the new current frame as the current frame and may also update the relative previous frame and subsequent frame that are displayed relative to the new current frame if the onion skinning is being displayed (Block 611).

If a selection to move the current frame selection forward is received, then the current frame is updated to be the subsequent frame in the sequence of available frames (Block 615). An update of the VR display screen is made by the software layer is made to show the new current frame as the current frame and may also update the relative previous frame and subsequent frame that are displayed relative to the new current frame if the onion skinning is being displayed (Block 617).

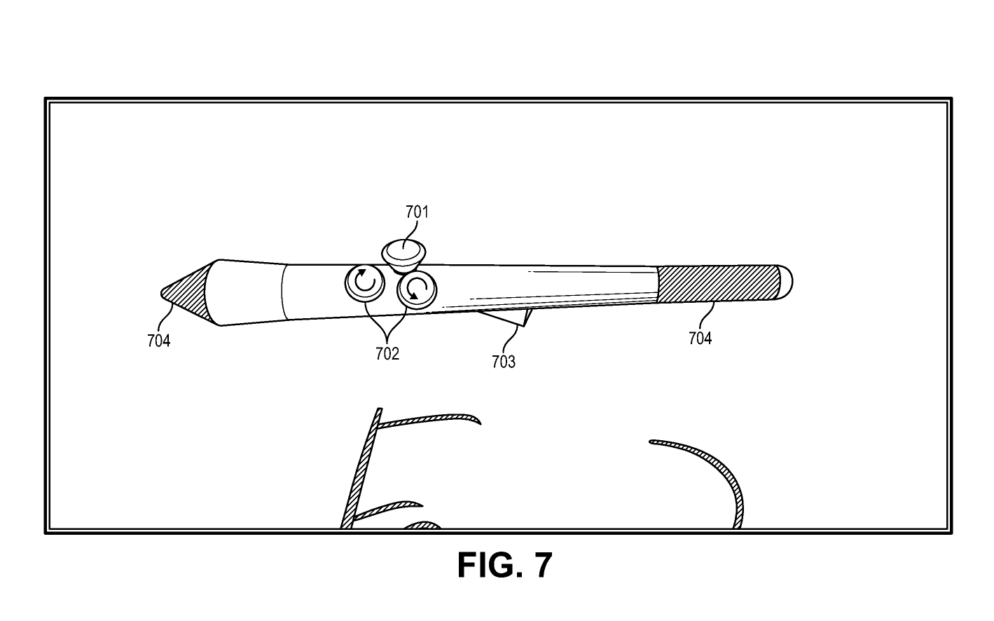

FIG. 7 is a diagram of one embodiment of a virtual art tool. The virtual art tool can be represented as any shape or design within the VR design environment. In some embodiments, the user may draw or similarly design the virtual art tool as it is represented in the VR design environment. The virtual art tool may include visual indicators of its current configuration and may include virtual input mechanisms such as buttons, and similar virtual or physical input mechanisms that can be activated by interaction in the VR design environment. In one example, a virtual and/or physical thumbstick 701 may be utilized such that rotating the thumbstick in a clockwise or counter-clockwise fashion to increase or decrease the size of the brush. The ring may be displayed when an input is received, e.g., a thumb is on the thumbstick; it increases or decreases in size based on the size of the brush.

In some embodiment, additional virtual or physical input mechanisms may include undo and redo buttons 702 that when activated (e.g., a press by the user) cause the software layer to remove or add content objects or sections thereof that have been recently added or deleted. In some embodiments, the visual art tool may include a trigger 703 or similar virtual or physical input mechanism that is tied to layer manipulation. For example, a user can grab with his hand (e.g., a third finger) to move and rotate an entire layer. The user does not need to be touching a specific object to move it around. Instead, the user may select a layer in order to move the entire layer. This only affects the currently selected layer so that every other layer stays in the same position and rotation. In further embodiments, the tip of the virtual art tool (and body) 704 may change color based on the user's selected color. When in delete mode, this color may flash, for example red and white.

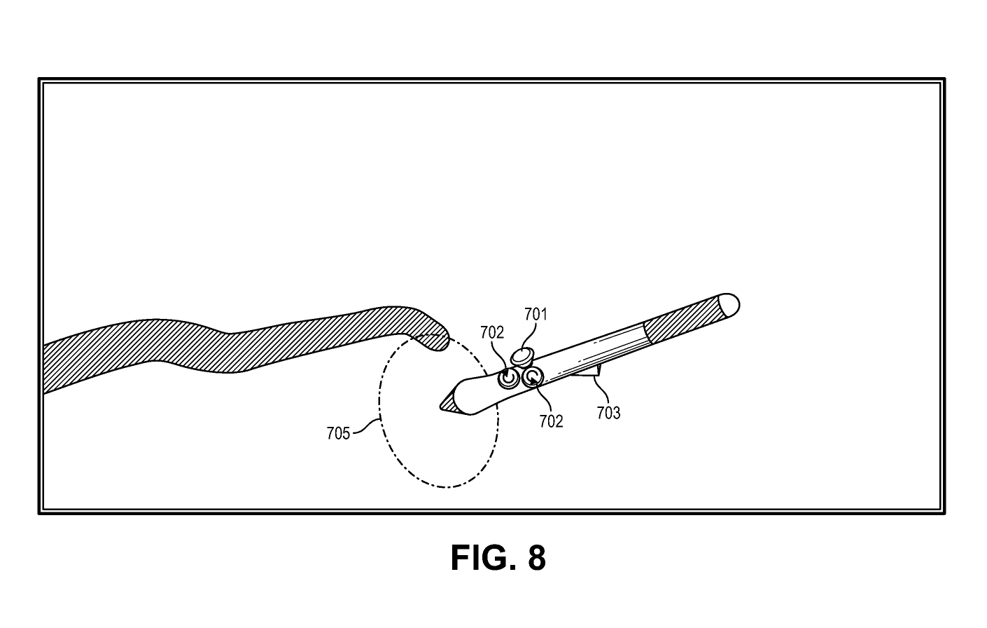

FIG. 8 is a diagram of one embodiment of the adjustment or configuration of the virtual art tool. A further illustration of the adjustment or configuration of the virtual art tool shows that a guide 705 may illustrate the selected brush size or similar area where an effect or change may be made in the VR design environment. Gestures such as the rotation of the hand or manipulation of the virtual or physical input mechanism 701-703 may also be used to adjust the configuration or settings of the virtual art tool. The virtual design palette can also be used in combination with the virtual art tool to configure the settings of the virtual art tool. The point or tip of the virtual art tool can identify the location within the VR design environment where ‘paint’ or lines or similar output from the virtual art tool is to be added to create new content and content objects.

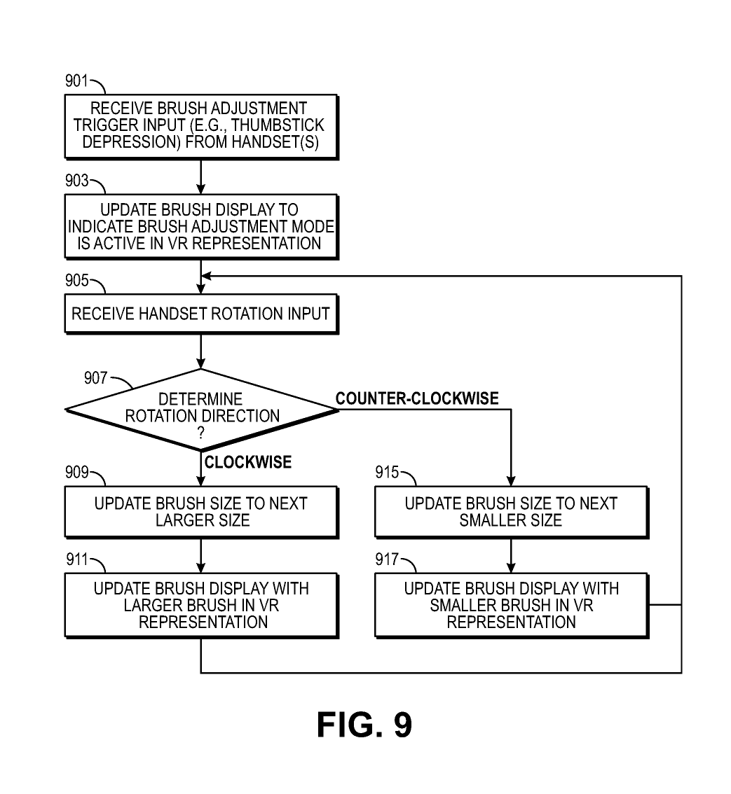

FIG. 9 is a flowchart of one embodiment of a process for the configuration of the virtual art tool. In one embodiment, a virtual art tool can be configured to dynamically adjust brush sizes for painting within the VR design environment. The process may be initiated by a user when the software layer receives a trigger input, either in the form of a virtual or physical input mechanism activation, a gesture or similar input (Block 901). The software layer then updates the VR display screen output to show an adjustment mode has been initiated (Block 903). A subsequent handset rotation input or similar input mechanism is then subsequently received by the software layer (Block 905).

The software layer determines whether the received input indicates a rotation direction, e.g., a clockwise or counter-clockwise rotation where a matching gesture or input is received (Block 907). Either direction can be tied to the increase or decrease of the brush size. In the example, a clockwise rotation causes the software layer to update the brush size to a next larger size (Block 909) in the art tool configuration settings. The software layer then updates the brush display with a larger brush in the VR representation of the virtual art tool (Block 911). If a counter-clockwise rotation is determined to be input, then the software layer updates the brush size to a next smaller size (Block 915) in the virtual art tool configuration settings. The software layer then updates the brush display with a smaller brush in the VR representation of the virtual art tool (Block 917). This process can continue to adjust the brush size if rotation input is repeatedly input. The brush adjustment process may end when the input ceases or when there is a timeout from a last input.

While the example of adjusting the brush size is provided for this process, similar processes for other virtual art tool configuration settings are also applicable including adjusting to eraser area, brush shapes, color selection, opacity settings and similar configuration setting that relate to the creation of content via the virtual art tool in the VR design environment.

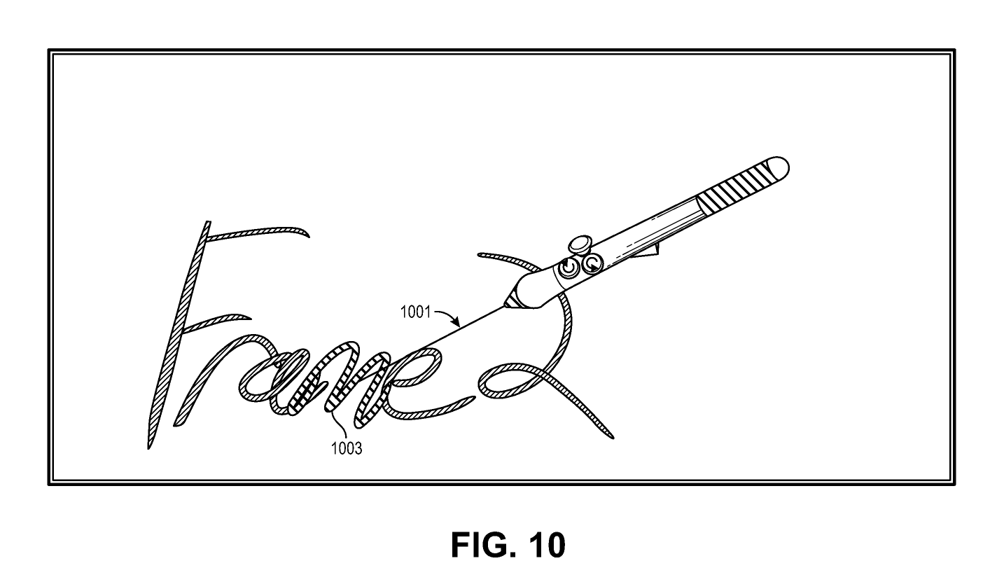

FIG. 10 is a diagram of one embodiment of the virtual art tool being utilized for erasing content. In one embodiment, the virtual art tool may include an erasure or delete stroke tool. This is one of many tools that will be available via the software layer and actualized via the virtual art tool and the virtual design palette. In this case, to delete a stroke, the correct layer must be selected. A user may point 1001 using the virtual art tool at a stroke in that layer, and pull the trigger to delete it. The layer or stroke to be deleted that is pointed at by the virtual art tool may be highlighted 1003 to enable the user to quickly verify that the correct item is to be deleted.

The illustrated embodiments have been presented by way of example and not limitation. The features of the virtual design palette and virtual art tool provided by the software layer and interacted with via the VR headset and peripherals of the hardware layer can be combined with additional features. Additional features can include a process for measuring pressure sensitivity via the virtual art tool and the virtual design palette where pressing only lightly on the virtual or physical trigger or similar input mechanism makes a brush stroke smaller or larger, broader or narrower, greater or less opacity or similar adjustment to the configuration settings.

Additional features include additional tools or components of these tools. This includes adjusting VR content item components using a tool where the user can interactively drag and manipulate an already-drawn stroke or mesh in the VR design environment by grabbing part of the content item. In some embodiments, no “bezier handles” or any kind of control point would be required. The tools can include an eraser tool that erases only parts of a stroke by rubbing the stroke with the virtual art tool. Embodiments also encompass enabling a user to create and edit their own brushes in terms of shapes, sizes and effects. It is possible for the software layer to enable the user to draw his own brush in the VR design environment and that shape that is drawn becomes the brush. Shapes that are created in the VR design environment can be converted into a “stamp” that the user can then draw or scatter around the VR design environment.

Clicking down on a thumbstick or similar virtual or physical input mechanism changes the “mode” for that particular hand. For example, clicking on the thumbstick associated with the virtual art tool allows the user to now rotate the thumbstick to change the opacity, or change the color swatch, or change the brush, or similar setting. The software layer can support importing any kind of media to allow not only for drawing but also for external models, images, and environments to be imported.

The VR design environment can also include a timeline view on a menu of the virtual design palette or similar tool. A timeline similar illustrates a sequence of existing frames that corresponds exactly to the “local” layers and persistent layers that the user has already created. This timeline will be able to be exported and imported, effectively allowing for a round-trip if the scene were edited outside of the software layer in another type of art application.

In some embodiments, the software layer may include a presenter mode where the user can record or stream live a fully-rendered version of a storyboard (i.e., a frame sequence or set of scenes which are groupings of the frames). The voice of the user can be recorded, any extra media is played or shown, and the whole storyboard can be played in real time. This recording can be simply exported into a video format (like an mp4), or the recording can quickly edit an entire frame sequence, effectively timing out a specific scene.

In a live streaming presentation mode, the presenter would be able to use the VR headset, and then any number of other people can “log in” as watch-only members with their own headsets or 360-degree tracked phones. These viewers can watch as the main user presents an entire storyboard or any subset of the set of frames, but each viewer has the whole 360-degree view of the VR design environment available to them. And if the viewers have positionally-tracked headsets and/or body tracking devices, they can interact with and move around the same space as the presenter rather than being stuck in one spot. All audio and video would be transmitted from the presenter so that all the viewers could hear and see everything simultaneously. In addition, any talking from the viewers may be fed back into everyone else's headphones, resulting in a joint audio/visual session.

In another mode, the software layer may provide an annotation mode. This may be integrated with the above presenter mode. This mode allows for edits to be tracked, such that another user may come into the VR design environment for a set of frames, a scene or storyboard, watch the sequence and suggest or make tracked edits. The comments may be in the form of an audio note, where the editor adds a note to either the whole frame or to a specific part of the frame by recording him/herself, or a drawn note, where the editor draws, deletes, or edits the sequence, or through a similar input. The software layer would keep track of these edits and present them as such to other users, who can either accept or suggest alternatives, allowing for collaboration.

In one embodiment, the software layer includes a collaboration mode where multiple people can edit the same VR design environment. In this case, multiple people can edit the same frames, scenes or storyboard, can interact with each other (hear and see each other), and otherwise create an entire sequence while all being in the same virtual space.

The above modes where multiple users are in the same space at the same time (whether they're editing or not) may be handled in various ways including where a primary instance of the software layer handles all interactions and all other devices running separate instances of the software layer connect directly to that one software layer handling the process, or a second embodiment where separate software layer instances operate or are synced to a server in the cloud, and that server handles all the interactions and any potential conflicts.

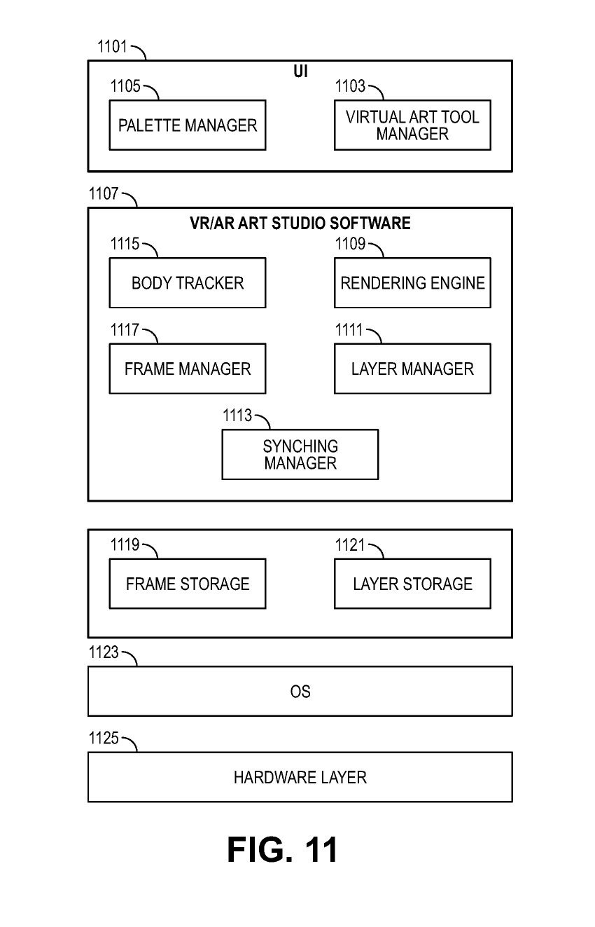

FIG. 11 is a diagram of one embodiment of a software architecture for the VR/AR design environment. The software architecture includes a software layer that implements the functions described herein above that operates on a hardware layer and in combination with peripheral devices as described herein above. The software layer includes a user interface 1101 and a VR/AR art studio software 1107. These components are supported by an operating system 1123 and the underlying hardware layer 1125.

The user interface 1101 provides functions that generate and display navigation and VR design environment interfaces for a user to interact with. There are many such functions, the illustrated embodiment shows those components most relevant to the features and functions described herein above, in particular a palette manager 1105 and a virtual art tool manager 1103. The palette manager 1105 generates the display, options and features of the virtual design palette described herein above. The virtual art tool manager 1103 generates the display, options and features of the virtual art tool described herein above.

The user interface 1101 is supported by and provides input to the VR/AR art studio software 1107. The VR/AR art studio software 1107 includes a rendering engine 1109, body tracker 1115, layer manager 1111, frame manager 1117, synching manager 1113 and similar components. These components work together to generate the VR design environment including the rendering and display thereof and the recording and storage thereof.

The rendering engine 1109 component is responsible for generating the visual representation of the VR design environment and sending a signal to the VR headset and any other feedback device (e.g., haptic feedback devices) to represent the VR design environment to the user. The body tracker 1115 receives input from body positioning devices such as handsets, body tracking equipment and similar devices including input mechanisms such as buttons, thumbsticks, triggers, and similar mechanisms and passes these inputs to the other components of the VR/AR art studio software 1107.

The frame manager 1117 tracks the contents of each frame including user created content as it is generated by the user via the virtual art tool and can be interacted with via the virtual design palette. The frame manager 1117 can organize and store data in frame storage 1119. The frame manager 1117 can organize the frames into a set of scenes or a storyboard which is a set of scenes. The frames may be stored in any format of organization in the frame storage 1119. Similarly, the layer manager 1111 manages the layers generated by a user in the VR design environment. The layer manager 1111 can enable the display and user interaction with the layers via the virtual design palette and the virtual art tool. The layers can be associated with specific frames or can be persistent across multiple frames. The layers can be stored in the layer storage 1121. The layers can have any format or organization in the layer storage 1121. Frames and layers can be exported using any format and combination to enable compatibility with other software.

A synching manager 1113 can provide the multi-user, presentation and collaboration functions discussed herein above. The synching manager 1113 can manage the communications with other VR/AR art studio software instances either local or remote to the hardware layer 1125 including sending frame and layer information to the other VR/AR art studio software instances and receiving such information from the other instances to be organized into a VR design environment that a local user of the VR/AR art studio software can interact with as though it were a locally generated VR design environment. Additional peripherals such as audio and video recording or input equipment can be utilized via the operating system 1123 and the hardware layer 1125 to enhance the information to be utilized in the multi-user, collaboration and presentation modes.

In additional embodiments, further components related to other features and functions can be included. Similarly, the organization of these components and functions is provided by way of example and not limitation. One skilled in the art would understand that the functions and features can be differently organized and grouped into other types and organization of components. Further, these components are understood to encompass software coding that is executable by the hardware layer. In other embodiments, any feature, component or process can be implemented in a specialized hardware component. The components of the software layer can be co-located or distributed over any number of computing devices and the example illustrated of a single operating system and hardware layer is provided by way of example and not limitation. The components and processes can be distributed in a cloud system or similar distributed environment or any hybrid computing environment.

Thus, a method, system and apparatus for generating content in a VR design environment has been described. It is to be understood that the above description is intended to be illustrative and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed:

1. A method of managing a virtual reality or augmented reality environment via a virtual design palette or a virtual art tool where a sequence of frames defines a sequence of changes to content in the virtual reality or augmented reality environment, the method comprising:
receiving a frame selection input;
determining whether the frame selection input is a frame change or frame display input;
determining a frame change direction where the frame selection input is a frame change; and
updating the virtual reality or augmented reality environment with the next selected frame as a current frame.

2. The method of claim 1, further comprising:
displaying a previous frame and a subsequent frame to the current frame.

3. The method of claim 2, wherein the previous frame and subsequent frame are displayed with a different opacity than the current frame.

4. The method of claim 1, further comprising:
changing a current displayed frame to a next subsequent frame in response to a clockwise rotation input.

5. The method of claim 1, wherein the frame selection input is an input from a virtual reality handset mechanism, body tracking mechanism, or gesture.

6. A method of managing a virtual reality or augmented reality environment via a virtual art tool where the virtual art tool generates content in the virtual reality or augmented reality environment based on a brush configuration setting, the method comprising:
receiving a brush selection input;
determining a brush selection input direction;
updating the brush configuration setting with a next larger brush setting in response to a clockwise rotation input; and
updating a representation of the virtual art tool in the virtual reality or augmented reality environment with an associated brush size corresponding to updated brush configuration setting.

7. The method of claim 6, further comprising:
displaying a brush size guide in the virtual reality or augmented reality environment in response to the brush selection input.

8. The method of claim 6, further comprising:
changing the brush configuration setting to a next smaller brush size in response to a counter-clockwise input.

9. The method of claim 6, further comprising:
updating a color of the virtual art tool in response to a selection of an erasing mode, new color swatch, or stroke deletion mode.

10. The method of claim 6, wherein the brush selection input is an input from a virtual reality handset mechanism, body tracking mechanism, or gesture.

11. A non-transitory computer-readable medium having stored therein a set of instructions to be executed by a computer system, which when executed cause the computer system to perform a set of operations for managing a virtual reality or augmented reality environment via a virtual design palette or a virtual art tool where a sequence of frames defines a sequence of changes to content in the virtual reality or augmented reality environment, the set of operations comprising:
receiving a frame selection input;
determining whether the frame selection input is a frame change or frame display input;
determining a frame change direction where the frame selection input is a frame change; and
updating the virtual reality or augmented reality environment with the next selected frame as a current frame.

12. The non-transitory computer-readable medium of claim 11, having further instructions stored therein, which when executed cause further operations comprising:
displaying a previous frame and a subsequent frame to the current frame.

13. The non-transitory computer-readable medium of claim 12, wherein the previous frame and subsequent frame are displayed with a different opacity than the current frame.

14. The non-transitory computer-readable medium of claim 11, having further instructions stored therein, which when executed cause further operations comprising:
changing a current displayed frame to a next subsequent frame in response to a clockwise rotation input.

15. The non-transitory computer-readable medium of claim 11, wherein the frame selection input is an input from a virtual reality handset mechanism, body tracking mechanism, or gesture.

16. A non-transitory computer-readable medium having stored therein a set of instructions to be executed by a computer system, which when executed cause the computer system to perform a set of operations for managing a virtual reality or augmented reality environment via a virtual art tool where the virtual art tool generates content in the virtual reality or augmented reality environment based on a brush configuration setting, the set of operations comprising:
receiving a brush selection input;
determining a brush selection input direction;
updating the brush configuration setting with a larger brush setting in response to a clockwise rotation input; and
updating a representation of the virtual art tool in the virtual reality or augmented reality environment with an associated brush size corresponding to updated brush configuration setting.

17. The non-transitory computer-readable medium of claim 16, having further instructions stored therein, which when executed cause further operations comprising:
displaying a brush size guide in the virtual reality or augmented reality environment in response to the brush selection input.

18. The non-transitory computer-readable medium of claim 16, having further instructions stored therein, which when executed cause further operations comprising:
changing the brush configuration setting to a next smaller brush size in response to a counter-clockwise input.

19. The non-transitory computer-readable medium of claim 16, having further instructions stored therein, which when executed cause further operations comprising:
updating a color of the virtual art tool in response to a selection of an erasing mode, new color swatch, or stroke deletion mode.

20. The non-transitory computer-readable medium of claim 16, wherein the brush selection input is an input from a virtual reality handset mechanism, body tracking mechanism, or gesture.
